(19) United States
(12) Patent Application Publication
(10) Pub. No.: US 2010/0043552 A1
(43) Pub. Date: Feb. 25, 2010

(54) 3-AXIAL ACCELEROMETER

(76) Inventors: Bjorn Henrik Stenbock Andersen, Kvistgaard (DK); Charles Edouard Mangeot, Hellerup (DK)

Correspondence Address: HARNESS, DICKEY & PIERCE, P.L.C., P.O. BOX 8910, RESTON, VA, 20195, US

(21) Appl. No.: 12/450,429

(22) PCT Filed: Mar. 26, 2008
(86) PCT No.: PCT/EP2008/053571

§ 371 Date: Oct. 22, 2009

Related U.S. Application Data
(60) Provisional application No. 60/907,200, filed on Mar. 26, 2007.

(30) Foreign Application Priority Data
Mar. 26, 2007 (DK) PA 2007 00466

(51) Int. Cl. G01P 15/09; G01P 15/18

(52) U.S. Cl. 73/514.29

(57) ABSTRACT

The invention provides an accelerometer comprised entirely in a single component of a piezoelectric or piezoresistive material. The accelerometer comprises three electrode regions each being adapted to provide a specific electrical pattern for specific acceleration directions. The invention further provides a method of determining acceleration.

### INTRODUCTION

The invention relates to a multilayer piezoelectric or piezoresistive ceramic accelerometer and more particularly to an improved 3-axial accelerometer.

### BACKGROUND OF THE INVENTION

Piezoelectric components are being used both as sensors and actuators, i.e. utilizing both the direct and the inverse piezoelectric effect, respectively. The direct piezoelectric effect means that when a mechanical load is applied to the piezoelectric material, a voltage is induced, and the inverse piezoelectric effect means that when a voltage is applied to a piezoelectric material, the material changes its shape and dimensions. In a similar manner, piezoresistive materials change resistance when a mechanical load is applied.

The purpose of the present invention is to improve the application of the direct piezoelectric effect, more specifically in the application of a piezoelectric component as a sensor in a 3-axial accelerometer.

Many industries are in need of 3-axial accelerometers, for example aerospace for structural integrity monitoring, engine vibration monitoring, power plants, wind mills, automotive or industry for maintenance prediction.

Current solutions for manufacturing 3-axial accelerometers generally consist of assembling 3 uniaxial accelerometers, each one generally containing 2-3 piezoelectric elements in shear mode. An example of such a uniaxial accelerometer is shown in U.S. Pat. No. 5,572,081. The accelerometers based on this type of design have a large number of parts, thus high price and large size. Also, they contain a large quantity of inactive material, which impacts their mass to performance ratio. Finally, their accuracy is limited by the numerous mechanical tolerances involved in their constitution. Especially, the orthogonality of the three measurement axes is often a weakness.

The U.S. Pat. No. 6,826,960 presents a triaxial acceleration sensor comprising an inertial mass suspended in three orthogonal directions by support members in a statically determinate structure.

### DESCRIPTION OF THE INVENTION

It is an object of the present invention to overcome the above mentioned problems. It is furthermore an object of the present invention to reduce manufacturing costs, weight and number of components in an accelerometer and an object to improve performance of the accelerometer. It is a further object to reduce the physical dimension of an accelerometer.

Accordingly, the invention, in a first aspect, provides an accelerometer comprising an active body of a piezo-material and at least a first, a second and a third region, each region comprising a plurality of first order electrodes being electrically separated from a plurality of second order electrodes.

In this connection, piezo-material is to be understood as either a piezo electric material or a piezo resistive material.

Under acceleration, due to the mass of the body of a piezoelectric or piezoresistive material, strain is induced in each region. Due to the characteristics of the piezoelectric or piezoresistive material, the strain generates a dielectric charge or a resistance, respectively. For each region separately, this charge can be collected or the resistance can be measured and analyzed to provide a measure of a three-dimensional acceleration profile. In particular, the accelerometer comprises three electrode regions each being adapted to provide a specific electrical pattern for specific acceleration directions.

To further specify the structure of the accelerometer, the following definitions apply throughout this document. Each electrode has an electrode thickness, an electrode width and an electrode length, the body has a body thickness, a body width and a body length. The direction of the thickness is also referred so as the X-direction, the direction of the width is referred to as the Y-direction and the direction of the length is referred to as the Z-direction—cf. the figures. By definition, the directions of the thickness, width and length of the electrodes correspond to those directions also of the thickness, width and length of the body, and by definition, they are perpendicular to each other thereby forming a Cartesian coordinate system with mutually perpendicular axes.

The electrodes are arranged to form at least one stack of electrodes in the body. This means that they are arranged one after each other in the thickness direction separated by a layer of the piezo-material—in the following description these layers are referred to as piezo-layers. The piezo-layers have a thickness which determines the distance between two parallel electrodes in a stack of electrodes. The width and length of the piezo-layers typically equals that of the electrodes which the piezo-layer separates. As the stacked electrodes typically extend parallel to each other, the piezo-layer thickness becomes constant for each piezo-layer. The piezo-layers do, however, not necessarily have to have the same thicknesses.

To provide a very compact design and potentially a more acceleration sensitive structure, the electrodes may be stacked in the thickness direction whereas they extend primarily in the lengthwise direction, being transverse or perpendicular to the thickness direction.

By “extend primarily” in a specific direction is in this connection meant that the largest dimension is in this direction. In case of the electrodes, the largest dimension would be either the width or length as the thickness is very small, typically less than 1/100 or even less than 1/1000 of the largest one of the width and length dimensions.

As an example, all the electrodes may have a rectangular shape, in which case the direction in which they extend primarily is the direction of the longest pair of side-edges.

All first order electrodes of one region could be electrically connected to carry the same electrical potential. Likewise, all second order electrodes of one region could be electrically connected to carry the same electrical potential. In fact, the first or the second order electrodes may function as a ground electrode pattern, and these electrodes may have identical electrical potential for all regions.

The active body may e.g. be a single body, and the internal electrodes may be integrated completely in the body so that merely connection points of the internal electrodes are accessible on an outer surface of the body where the connection points are joined with the external electrodes. The location of the connection points on the outer surface can differ depending on the layout of the internal electrodes, and typically, the location can be chosen freely. The single body could e.g. be co-fired which in this regards means that a single green body is made, and subsequently fired to form one singe piezoelectric or piezoresistive element. This renders subsequent adhesive bonding between different components unnecessary, and the embedding of all regions in one co-fired body may further increase the accuracy of determination of the acceleration since it prevents mutual displacement between the regions.

To increase the impact of acceleration on the active body and thereby to amplify the electrical charge in the external electrodes or the resistance between the electrodes, the accelerometer may further comprise an inactive body attached to the active body. In one embodiment, the inactive body is identical to the active body or at least has an identical mass. The inactive body could, however, also have a very small mass, e.g. smaller than the mass of the active body, or it could be a body which is heavy relative to the active body, e.g. with a mass in the order of 1-10 times the mass of the active body.

The inactive body could be located directly adjacent the active body, e.g. adhesively bonded thereto, or even forming part thereof. Alternatively, to amplify the electrical charge or resistance further, the inactive body could be located at a distance from the active body so that acceleration of the inactive body influences the active body via a connecting rod or via a similar stiff element.

To facilitate manufacturing, the inactive body could be made from a piezoelectric or piezoresistive material, e.g. the same material which forms the active body, and the two bodies could be continuously formed in a single co-fired piezoelectric or piezoresistive material. Again, co-fired means that a single green body is made and subsequently fired to form one single piezoelectric or piezoresistive element. This means that all three regions are fixedly bonded in one single body.

The internal electrodes could be identical or they could have different shapes. As an example, the primary internal electrodes may have a shape which is different from at least one of the secondary internal electrodes and the tertiary internal electrodes. The internal electrodes are preferably completely enclosed in piezoelectric or piezoresistive material. Oppositely, the external electrodes could have identical connection points on an outer surface of the active body, or they may have individually shaped connection points on the outer surface.

The accelerometer may function as an accelerometer in connection with any kind of electrical system with or without any conversion calculation for translating the electrical charge or resistance into a specific acceleration. As an example, one electrical system may utilize the sensor simply by surveying the electrical charge or resistance in or between each of the primary, secondary or tertiary electrodes separately or in combination, and by comparing this charge or resistance with reference charge or resistance, a specific acceleration pattern can be recognized. This could be used e.g. to identify a crash in a vehicle or to identify similar specific situations of a mechanical system. The accelerometer may further comprise a control system in communication with the external electrodes, the control system being adapted to determine an electrical charge in the electrodes or a resistance between electrodes and from the electrical charge or resistance, to determine a magnitude of acceleration in three directions. Such a control system may incorporate at least one charge amplifier and processing means programmed to identify acceleration from the electrical charges in the external electrodes. In particular, the system could be programmed to identify acceleration in any direction in space.

As it will be described further with reference to the drawings, the accelerometer may comprise at least one additional temperature compensation region comprising first order temperature compensation electrodes and second order temperature compensation electrodes embedded in the active body.

To distinguish between the regions, those regions which are not for temperature compensation are in the following referred to as “sensing regions”.

The temperature compensation regions are arranged such that the a dielectric charge or change in resistance generated therein upon acceleration is equal and opposite to the signal generated in one or more of the other regions whereas the signal generated therein upon temperature change is equal and of same sign as the signal generated in one or more of the other regions.

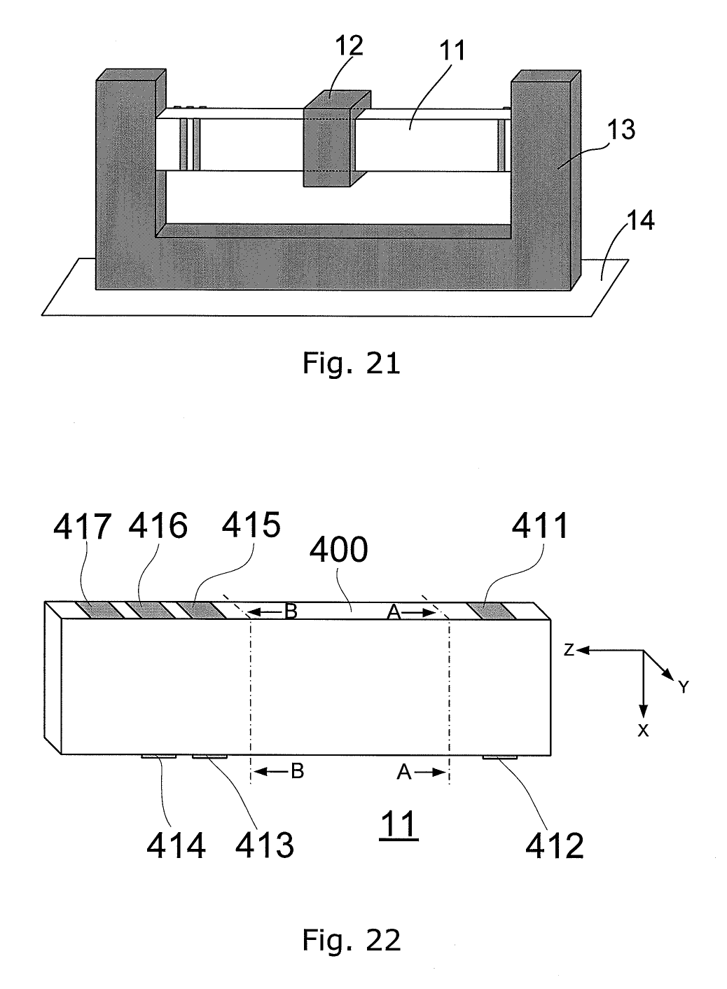

This function may be achieved e.g. with temperature compensation regions which, for a given sensing region, are placed symmetrically with regard to a plane perpendicular to the considered sensing direction, containing the geometrical centre point of the device. This is exemplified later with reference to the FIGS. 14 and 21.

The aforementioned control system may be adapted to communicate with the electrodes in the temperature compensation and to compare the temperature compensation signal with the acceleration signal to compensate the acceleration profile for temperature changes.

To facilitate manufacturing, the basis electrodes may all have substantially identical electrical potential and they may all be joined by one single external basis electrodes. In this embodiment, the accelerometer may in total have a number of four connection points externally, i.e. a basis, a primary, a secondary and a tertiary connection point corresponding to each of the external electrodes. The one single common basis electrode may further increase accuracy since all regions operate with same basis, i.e. the charge or resistance in or between the primary, secondary and tertiary electrodes are determined relative to the same common return path or “zero voltage” reference level.

At least one of the active body and the inactive body may have a shape which is cylindrical, triangular, or spherical or in fact have any shape. In one embodiment, the active and inactive bodies together form an element with a cylindrical or spherical shape.

To decrease the effect of changes in temperature on the determination of the acceleration, the accelerometer may further comprise one, two or three additional external electrodes each being in electrical conductive contact with corresponding sets of internal electrodes. In these embodiments, the accelerometer further comprises a corresponding number of additional regions in which a portion of the internal basis electrodes are arranged alternating internal electrodes.

In a second aspect, the invention provides a method of determining acceleration by use of a body of a piezo material which comprises at least three sensing regions, where each sensing region comprises an individual set of electrodes separated by piezoelectric or piezoresistive material, the method comprising the step of processing electrical signals from each sensing region to provide an acceleration profile of the body. The method may further comprise the step of combining an electrical signal from each of the sensing regions in one single model which describes a correlation between the electrical signals and an acceleration of a substrate to which the piezoelectric body is attached.

The method may further comprise the step of combining an electrical signal from each of the sensing regions with a signal from a temperature compensation region to provide a more temperature independent acceleration profile of the body.

The method may further comprise the step of comparing an electrical signal from each of the sensing regions with a reference value, and considering a specific acceleration state based on the comparison.

Throughout the above-description, and in the following detailed description, accelerometers with three, four, five and six regions are disclosed. However, the invention further provides an accelerometer with only two regions adapted for sensing acceleration in a plane. In a fourth and fifth aspect, the invention provides such an accelerometer with at least two regions. In particular, the invention provides an accelerometer for sensing acceleration, the accelerometer comprises an active body of a piezoelectric or piezoresistive material and at least two regions, each region having an electrode pattern, characterized in that the patterns are adapted to provide different electrical signals for acceleration in one specific direction. By different electrical signals is means either different electrical charges in electrodes which are embedded in the active body or different electrical resistance between electrodes embedded in the active body. The two dimensional accelerometer may be combined with temperature compensation by use of additional regions with electrodes.

### DETAILED DESCRIPTION OF THE INVENTION

In the following, embodiments of the invention will be described with reference to the drawings in which:

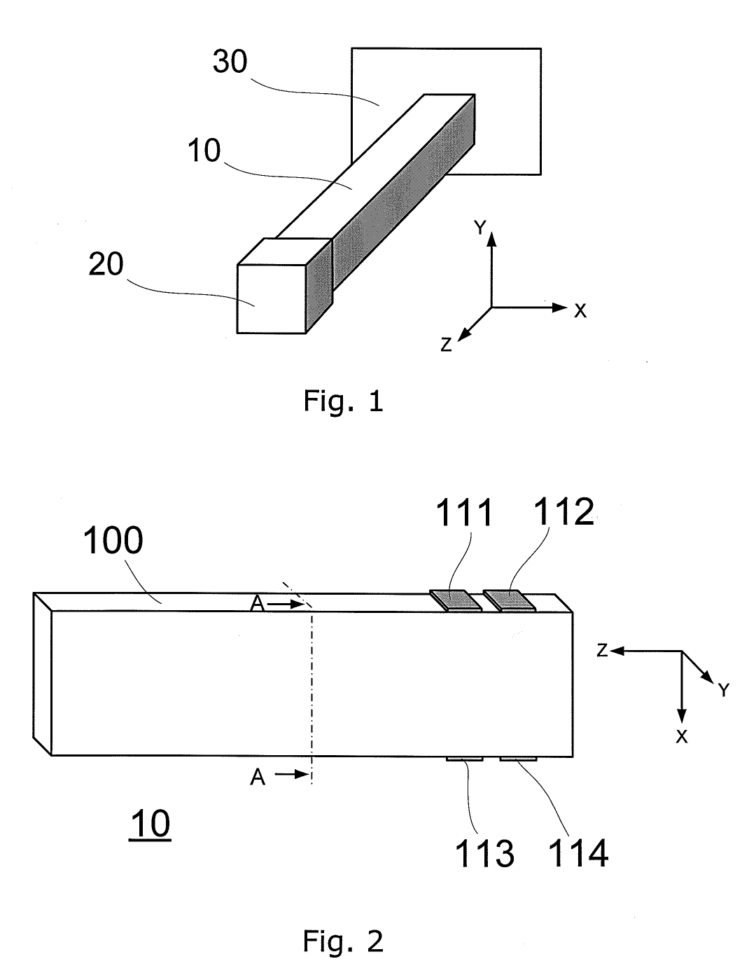

FIG. 1 illustrates a schematic isometric view of the accelerometer assembly in a first embodiment of the invention;

FIG. 2 illustrates an isometric top view of the active body of the 3-axial piezoelectric accelerometer in the first embodiment of the invention;

FIG. 3 illustrates a side view of the active body of the 3-axial piezoelectric accelerometer in FIG. 2;

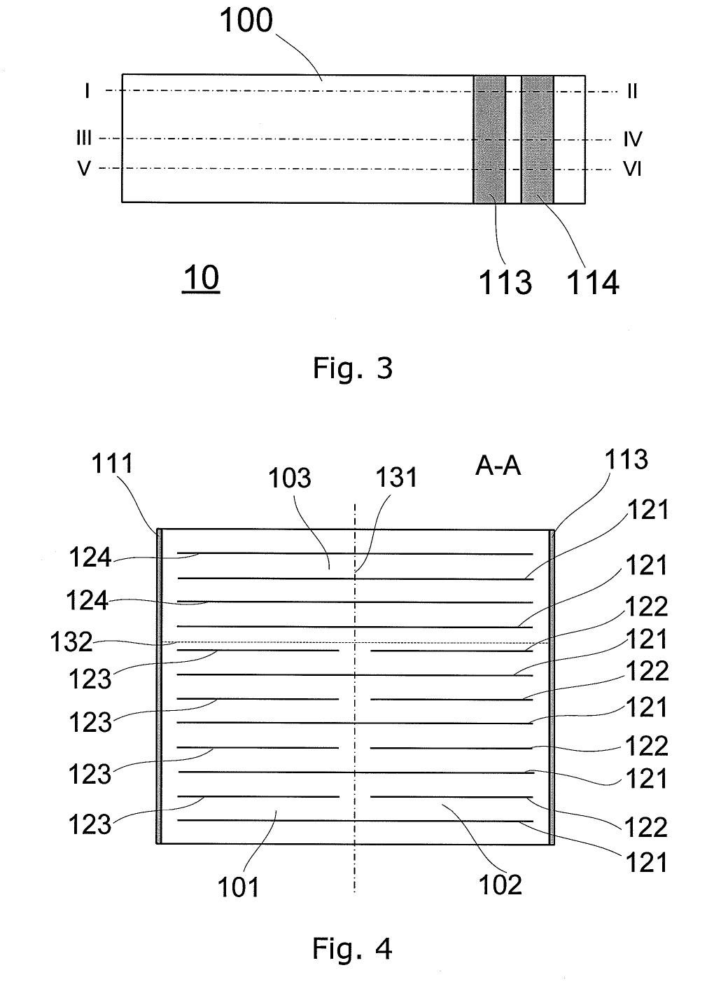

FIG. 4 illustrates a cross-sectional view of the active body of the 3-axial piezoelectric accelerometer, taken along the line A-A on FIG. 2;

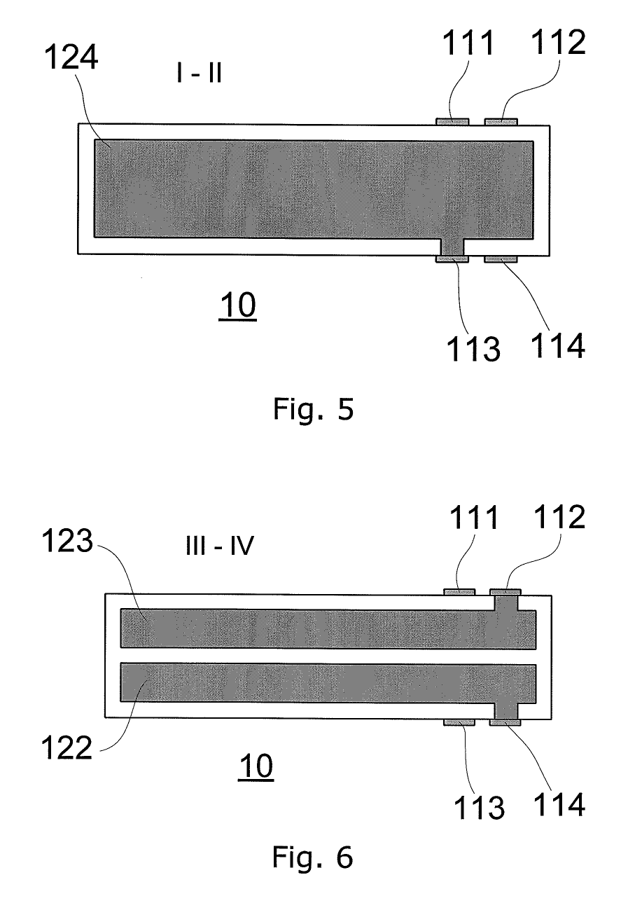

FIG. 5 illustrates a cross-sectional top view of the active body of the 3-axial piezoelectric accelerometer, taken along the line I-II on FIG. 3;

FIG. 6 illustrates a cross-sectional top view of the active body of the 3-axial piezoelectric accelerometer, taken along the line III-IV on FIG. 3;

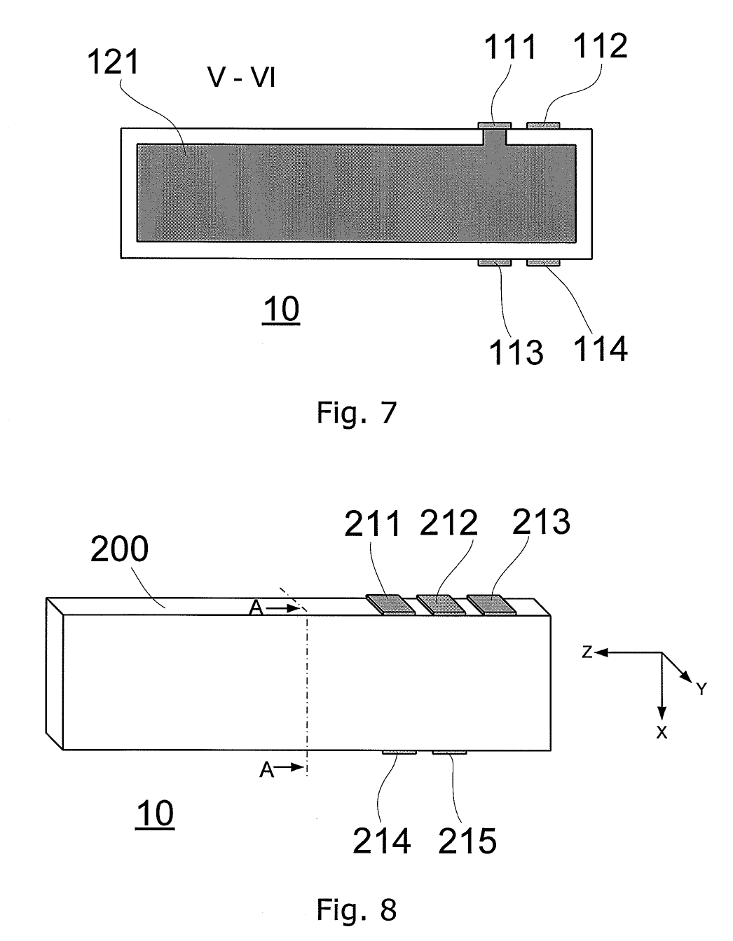

FIG. 7 illustrates a cross-sectional top view of the active body of the 3-axial piezoelectric accelerometer, taken along the line V-VI on FIG. 3;

FIG. 8 illustrates an isometric top view of the active body of the 3-axial piezoelectric accelerometer in a second embodiment of the invention in which the active body consists of four regions;

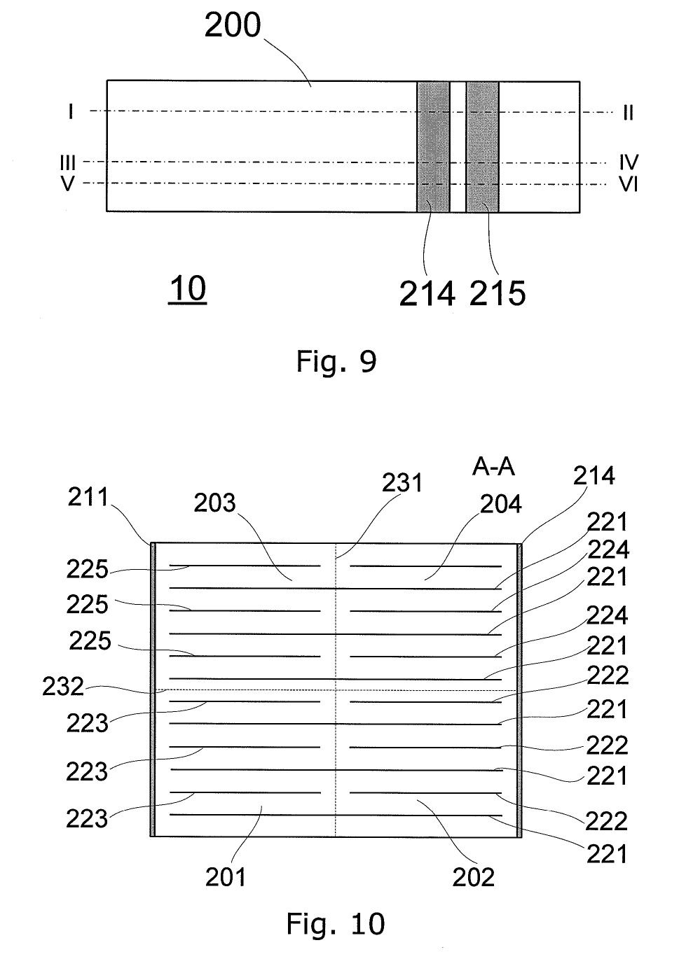

FIG. 9 illustrates a side view of the active body in the second embodiment of the invention shown in FIG. 8;

FIG. 10 illustrates a cross-sectional view of the active body in the second embodiment of the invention, taken along the line A-A on FIG. 8;

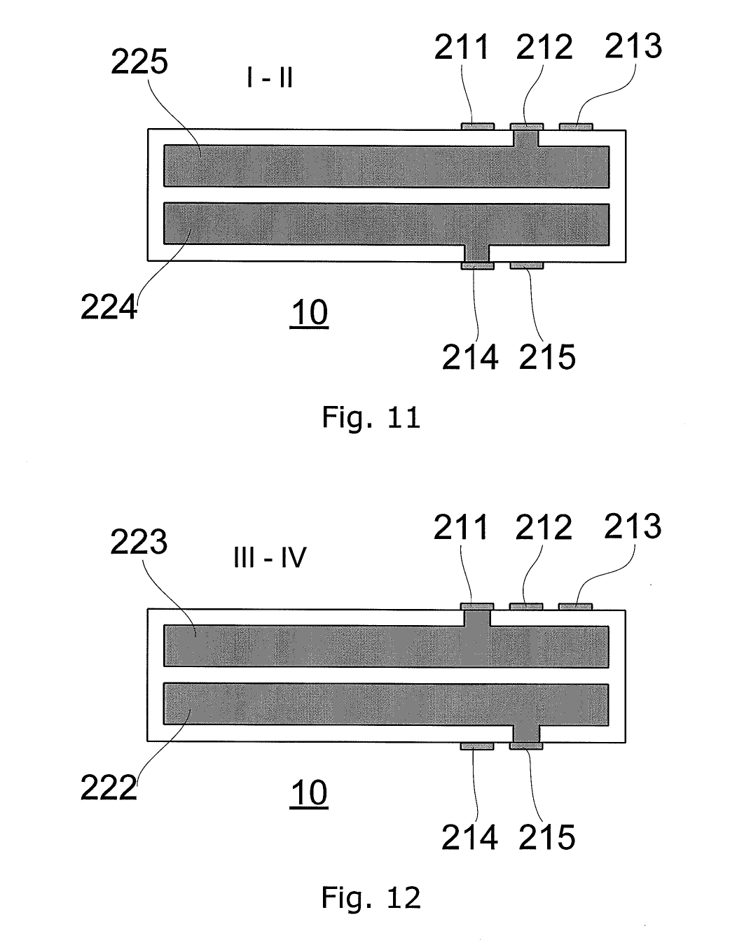

FIG. 11 illustrates a cross-sectional top view of the active body in the second embodiment of the invention, taken along the line I-II on FIG. 9;

FIG. 12 illustrates a cross-sectional top view of the active body in the second embodiment of the invention, taken along the line III-IV on FIG. 9;

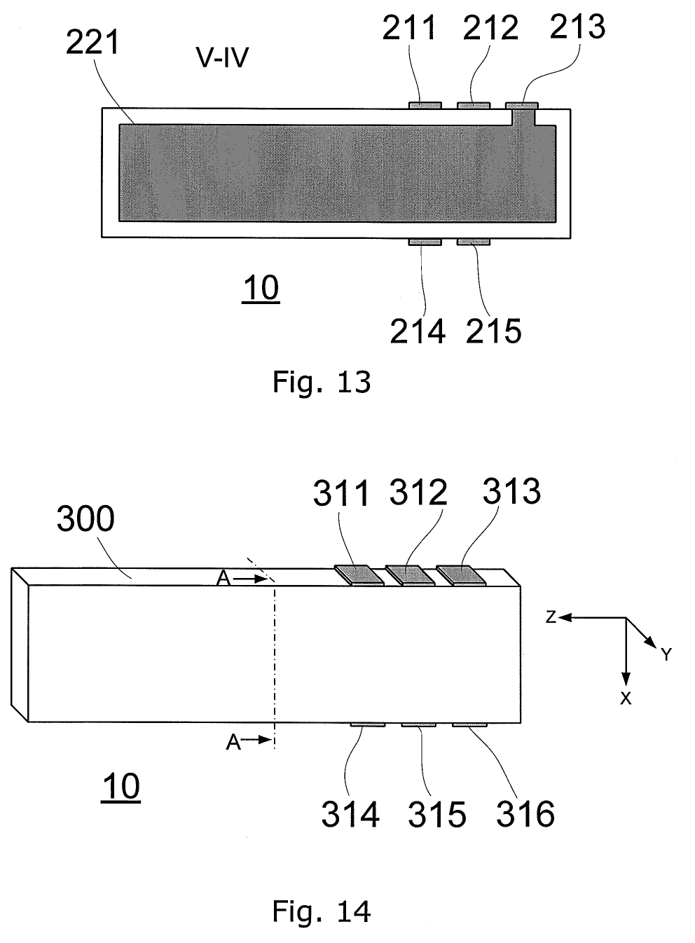

FIG. 13 illustrates a cross-sectional top view of the active body in the second embodiment of the invention, taken along the line V-VI on FIG. 9;

FIG. 14 illustrates an isometric top view of the active body in a third embodiment of the invention, in which the active body comprises five regions;

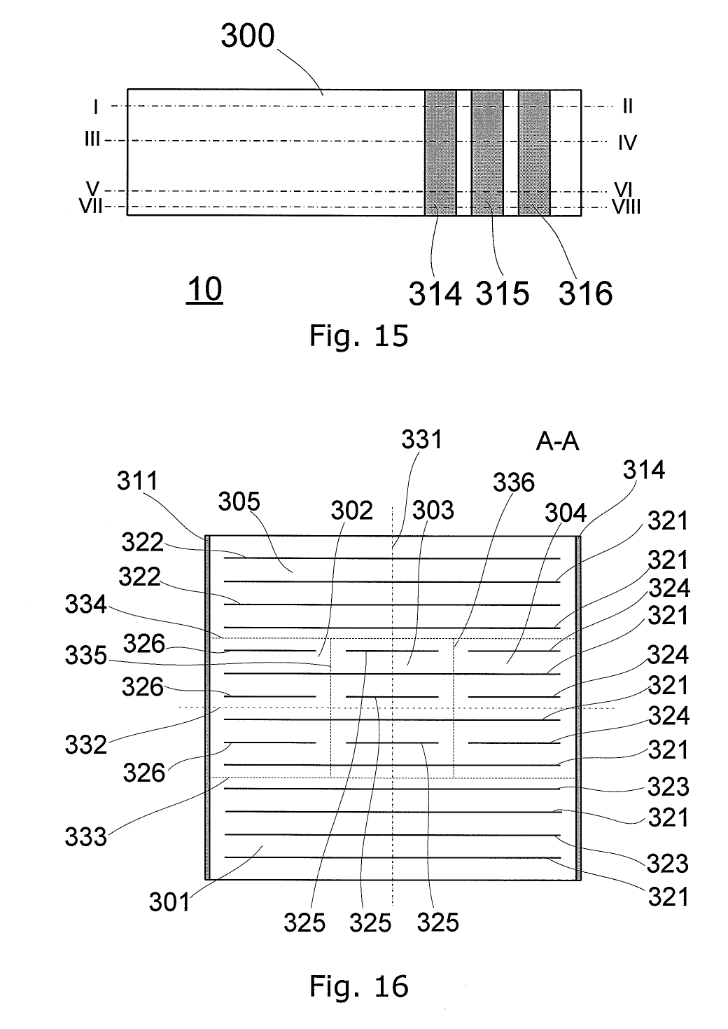

FIG. 15 illustrates a side view of the active body of the active body in the third embodiment of the invention, shown in FIG. 14;

FIG. 16 illustrates a cross-sectional view of the active body in the third embodiment of the invention, taken along the line A-A on FIG. 14;

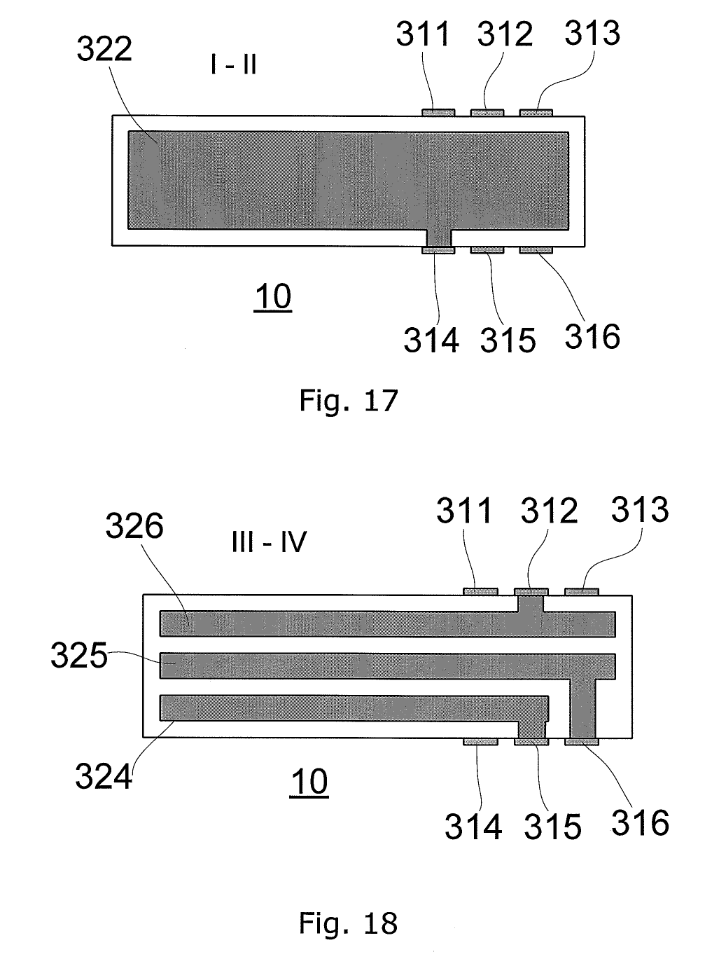

FIG. 17 illustrates a cross-sectional top view of the active body in the third embodiment of the invention, taken along the line I-II on FIG. 15;

FIG. 18 illustrates a cross-sectional top view of the active body in the third embodiment of the invention, taken along the line III-IV on FIG. 15;

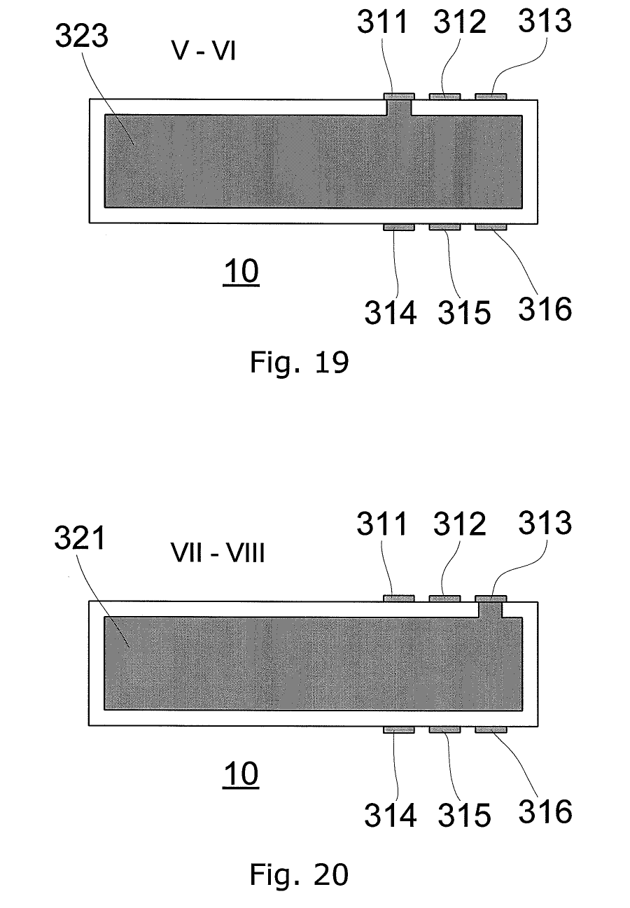

FIG. 19 illustrates a cross-sectional top view of the active body in the third embodiment of the invention, taken along the line V-VI on FIG. 15;

FIG. 20 illustrates a cross-sectional top view of the active body in the third embodiment of the invention, taken along the line VII-VIII on FIG. 15;

FIG. 21 illustrates a schematic isometric view of the accelerometer assembly in a fourth embodiment of the invention in which the active body consists of six regions, and in which the active body is fixed in both ends;

FIG. 22 illustrates a top view of the active body of the 3-axial piezoelectric accelerometer in the fourth embodiment of the invention;

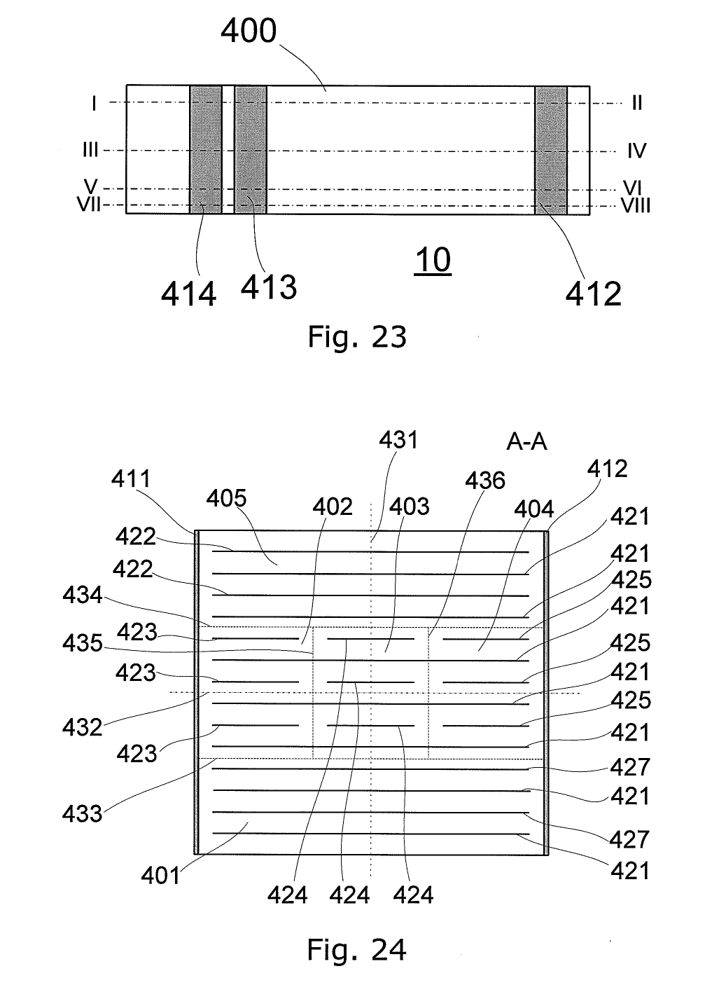

FIG. 23 illustrates a side view of the active body in the fourth embodiment of the invention, shown in FIG. 22;

FIG. 24 illustrates a cross-sectional view of the active body in the fourth embodiment of the invention, taken along the line A-A on FIG. 22;

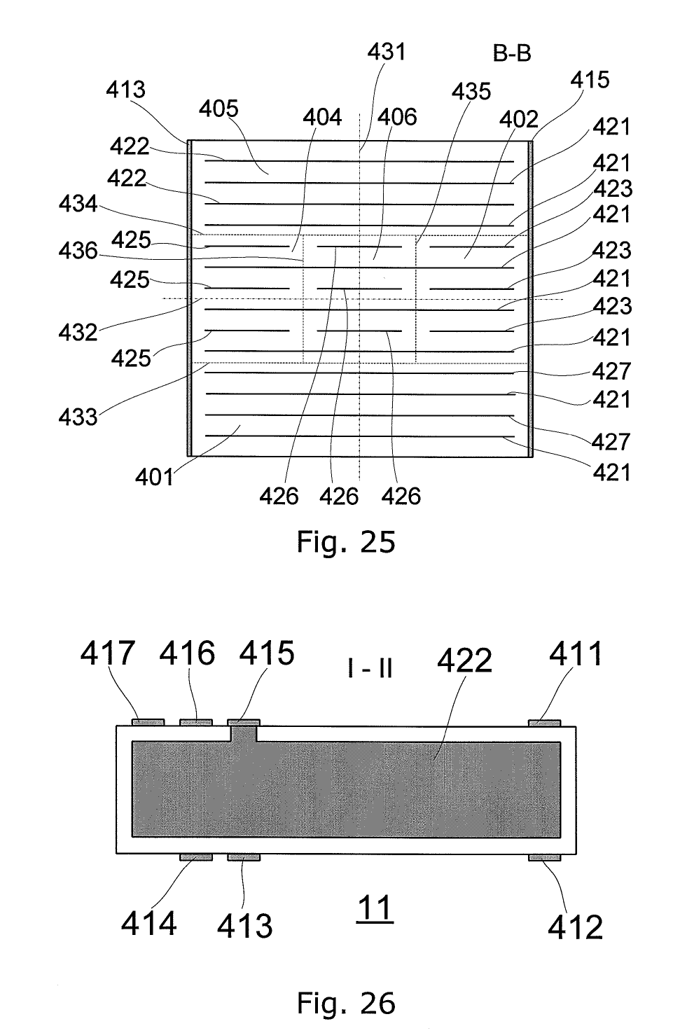

FIG. 25 illustrates a cross-sectional view of the active body in the fourth embodiment of the invention, taken along the line B-B on FIG. 22;

FIG. 26 illustrates a cross-sectional top view of the active body in the fourth embodiment of the invention, taken along the line I-II on FIG. 23;

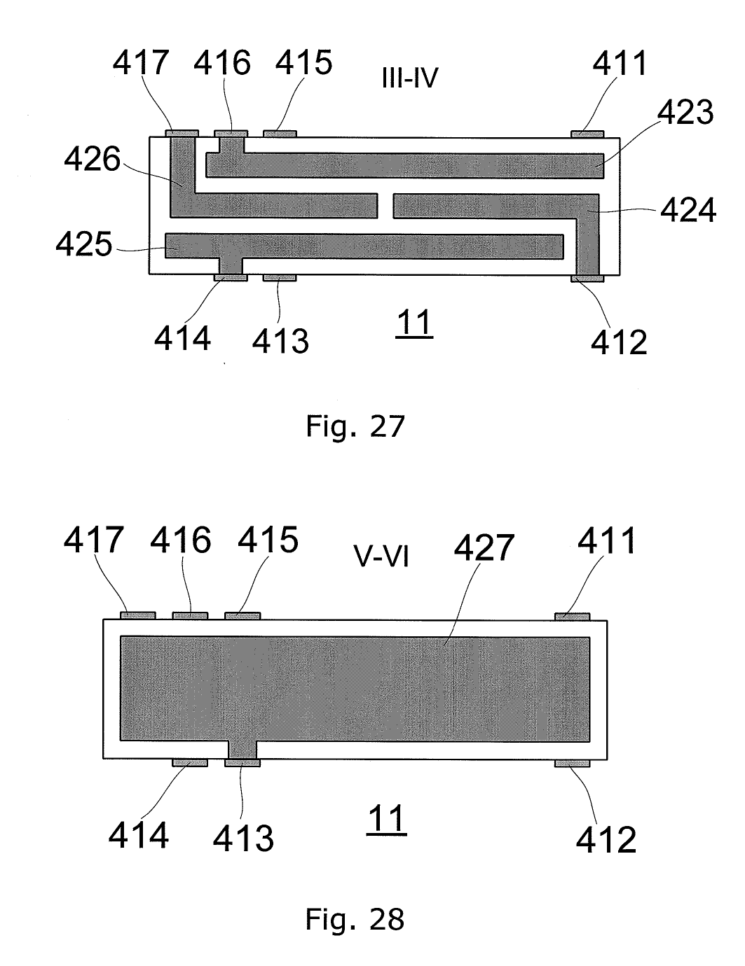

FIG. 27 illustrates a cross-sectional top view of the active body in the fourth embodiment of the invention, taken along the line III-IV on FIG. 23;

FIG. 28 illustrates a cross-sectional top view of the active body in the fourth embodiment of the invention, taken along the line V-VI on FIG. 23;

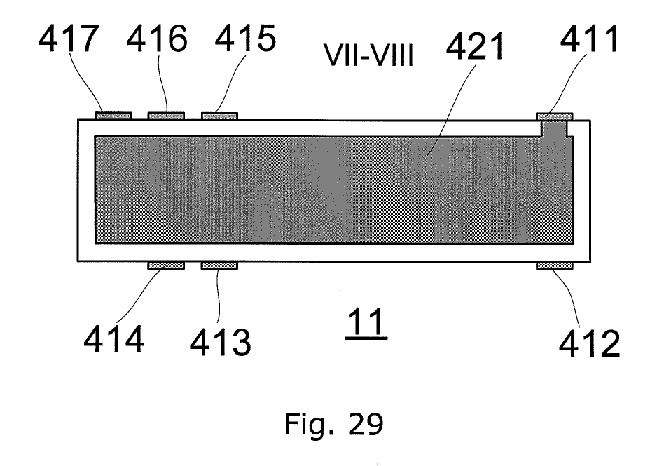

FIG. 29 illustrates a cross-sectional top view of the active body in the fourth embodiment of the invention, taken along the line VII-VIII on FIG. 23;

FIG. 1 illustrates a 3-axial piezoelectric accelerometer, comprising a multilayer piezoelectric ceramic active body 10 and an inactive body 20. Throughout the detailed description, the active bodies are piezoelectric bodies, but they could also have been piezoresistive bodies. When the bodies are piezoelectric, the charges on the electrodes are indicative of an acceleration, and when the active bodies are piezoresistive, the resistances between electrodes are indicative of an acceleration.

The active body 10 comprises at least three regions. As indicated all three regions are comprised in one single body of piezoelectric material in which internal electrodes are arranged in accordance with the following description. The illustrated accelerometer facilitates determination of acceleration in any direction in a three-dimensional space.

The multilayer piezoelectric ceramic active body 10 and the inactive body 20 are made as two individual bodies. The active body 10 is subsequently joined to the inactive body 20 at one end e.g. adhesively or by mechanical clamping. At its other end, the active body 10 is joined, adhesively or by mechanical clamping, to the reference system 30, e.g. a body of a car engine or any other component for which acceleration measurements are desired.

The inactive body 20 is typically made of a high density material such as steel. The inactive body (mass) 20 is used to adjust the sensitivity of the sensor. The higher the mass of the inactive body is, the higher is also the compression and pull forces in the active body and thus the voltage output for a given acceleration of the substrate. For operation at high frequencies, smaller masses may be preferred. Accordingly, the invention may provide an accelerometer where the mass of the inactive body is selectable, and a method of selecting a mass based on the frequency.

A three-axial accelerometer according to the invention comprises a multilayer piezoelectric ceramic active body 10, in the following just called the active body 10, according to one of the embodiments of the invention, as illustrated in FIGS. 2 to 7, comprises an external basis electrode 111 in conductive contact with a plurality of internal basis electrodes 121. The accelerometer further comprises an external primary-electrode 112 in electrical conductive contact with a plurality of internal primary-electrodes 122, an external secondary-electrode 113 in electrical conductive contact with a plurality of internal secondary-electrodes 123, and an external tertiary-electrode 114 in electrical conductive contact with a plurality of internal tertiary-electrodes 124.

As shown in FIG. 2, the external electrodes are located on an outer surface of the body 100 so that they are accessible e.g. for a control system for processing an electrical charge in the external electrodes. One way of locating the external electrodes on the outer surface is illustrated in FIG. 2. However, the external electrodes may form any kind of terminal at any location on the outer surface of the active body. The internal electrodes typically extend to an outer surface of the active body, at which outer surface they are joined with the external electrodes.

As shown in FIG. 4, the above-mentioned primary, secondary and tertiary internal electrodes define a primary-region 102 in which a primary-portion of the internal basis electrodes are arranged alternating internal primary-electrodes, a secondary-region 101 in which a secondary-portion of the internal basis electrodes are arranged alternating internal secondary-electrodes, and a tertiary-region 103 in which a tertiary-portion of the internal basis electrodes are arranged alternating internal tertiary-electrodes. As shown, the piezoelectric material of the single, co-fired body 100 forms electrical separation between each internal electrode.

The external basis electrode 111 is a common electrode which connects the three regions to a common ground potential. The internal electrodes in the three regions 101, 102, 103 collect dielectric charge (generated by mechanical stress) and thereby reach a voltage potential with regards to external electrode 111.

A multilayer piezoelectric accelerometer device according to a first of the embodiments of the present invention is characterized in that the device is a planar, e.g. parallelepiped piezoelectric accelerometer device comprising three layer regions lying one upon the other or next to each other, all three layer regions being made of a piezoelectric ceramic material and incorporating therein internal electrodes for sensing internal stress and supplying voltage to the external electrodes, and all three layer regions being formed integrally with each other, wherein said accelerometer device has a rectangular top view. All regions may be multilayer piezoelectric regions, i.e. regions comprising a plurality of layers of ceramic alternating internal electrodes or single layer piezoelectric regions or one or more of the regions may be a multilayer piezoelectric region while the other regions are single layer piezoelectric regions. The multilayer regions may comprise any number of layers of ceramic alternating internal electrodes, e.g. in the range of 2, 3, 4, 5, 6, 7, 8 or 9 layers or even 10, 20, 30,40, 50, 60, 70, 80, 90 or even more than 100 layers.

Again referring to FIGS. 2-7 the device 10 has a parallelepiped form and is composed of three layer regions 101, 102 and 103 as shown in FIG. 4. The primary and secondary regions 101 and 102 do not necessarily have to be of the same thickness as the tertiary region 103, and similarly the primary and secondary regions 101 and 102, do not necessarily have to be of the same width.

An isometric top view and a side view of the active body 10, in the first of the embodiments of the invention, are shown in FIGS. 2 and 3 respectively. In FIG. 3 the external electrodes 113 and 114 can be seen in their full extension.

The internal electrode configuration of the multilayer piezoelectric active body 10 in the first embodiment of the invention is illustrated in FIGS. 4 to 7. The active body 10 comprises three regions 101-103 which extend through the length of the active body 10.

As illustrated on FIG. 4 the primary region 101 is situated below the dotted line 132 and left for the neutral plane 131, the secondary region 102 is situated below the dotted line 132 and right for the neutral plane 131. The tertiary region 103 is situated above the dotted line 132.

The primary region 101 (FIG. 4) contains alternately a primary portion of the internal basis electrodes 121 (FIGS. 4 and 7), and primary-internal electrodes 123 (FIGS. 4 and 6).

The internal basis electrode could e.g. be a ground electrode, e.g. an electrode with a negatively charge relative to adjacent electrodes. The internal primary-electrodes (as well as the internal-secondary electrodes and internal tertiary-electrodes) could e.g. be electrodes with a positive charge relative to adjacent electrodes. The secondary region 102 (FIG. 4) contains alternately a secondary portion of the basis internal electrodes 121 (FIGS. 4 and 7) and secondary-internal electrodes 122 (FIGS. 4 and 6). The tertiary region 103 (FIG. 4) contains alternately a tertiary portion of the internal basis electrodes 121 (FIGS. 4 and 7) and tertiary-internal electrodes 124 (FIGS. 4 and 5). All internal electrodes are insulated from each other by the ceramic material. They are enclosed in the ceramic block, except at selected places where they extend to the edge of the active body to connect with the external electrodes 111 to 114 (FIGS. 5-7). All the basis internal electrodes 121 are connected to the basis-external electrode 111. Accordingly all the primary-internal electrodes 123 of the primary region 101 are connected to the primary-external electrode 112, all the secondary-internal electrodes 122 of the secondary region 102 are connected to the secondary-external electrode 114, and all the tertiary-internal electrodes 124 of the tertiary region 103 are connected to the tertiary-external electrode 113.

In the following the internal basis electrodes are in general referred to as negative electrodes, and the internal primary-electrodes, internal secondary-electrodes etc. are in general referred to as positive electrodes. This is for illustrative purpose, and opposite relative charges may equally be considered.

The primary and secondary layer regions 101 and 102 are formed, for example, in the following way. First, a piece of ceramic tape-casted film of predetermined thickness is placed on a carrier block. Then, a conductive metal paste of e.g. a mixture of silver, palladium and platinum is screen-printed on the above first ceramic layer and dried to form the first negative internal electrode 121. A piece of ceramic film is again put on top of the first negative internal electrode 121. Again a metal paste is screen printed on the second ceramic layer, this time in a printer with the print design to form the positive internal electrodes 122 and 123. Thereafter, the latter two steps are repeated until the primary and secondary layer regions 101 and 102 are completely formed.

The tertiary layer region 103 is formed, for example, in the following way. First, a piece of ceramic tape-casted film of predetermined thickness is placed on the last positive internal electrodes 122 and 123. Then, a conductive metal paste of e.g. a mixture of silver, palladium and platinum is screen-printed on the above first ceramic layer and dried to form the negative internal electrode 121. A piece of ceramic film is again put on top of the negative internal electrode 121. Again a metal paste is screen printed on the second ceramic layer, this time in a printer with the print design to form the positive internal electrode 124. Thereafter, the latter two steps are repeated, alternating negative internal electrodes 121 with positive internal electrode 124, until the tertiary layer region 103 is completely formed.

The piezoelectric multilayer device 10 thus formed is subjected to a pressing process, a binder-burnout process and a sintering process in a known manner. Either before or after sintering process, the final dimensions of the piezoelectric multilayer device is formed by a conventional dicing method, for example, diamond blade dicing. Subsequently a metal paste of for example silver is screen printed on the piezoelectric multilayer device to form the four external electrodes, or terminals, 111, 112, 113 and 114 shown on FIGS. 2-7, with the purpose of connecting the internal electrodes. In this manner the terminal 111 (negative external electrode) is connecting all the layers of negative internal electrodes 121, the terminal 112 (positive external electrode) is connecting all the layers of positive internal electrodes 123, the terminal 113 (positive external electrode) is connecting all the layers of positive internal electrodes 124 and the terminal 114 (positive external electrode) is connecting all the layers of positive internal electrodes 122. Finally a poling is given to the three layer regions 101, 102 and 103 by known techniques.

The piezoelectric multilayer device may have one inactive electrically insulating layer of ceramic at the top and the bottom of their active parts as cover layers. The operating principle of the piezoelectric multilayer device 10 having the above structure is as follows:

The acceleration of the substrate in each of the three axes generates different stresses in each one of the three regions 101, 102 and 103. Due to the properties of the piezoelectric material, these stresses generate dielectric charges which are collected by the internal electrodes 121 to 124 and the external electrodes 111 to 114.

When the substrate is accelerated in the X direction, due to the weight of the inactive body added to its own weight, the active body experiences strain and stress. In average, the region 101 is compressed. Region 102 is submitted to tensile stresses. Region 103 also bends, however the neutral plane 131 of the active body being placed in its middle, the average stress in this region is zero.

Due to the properties of the piezoelectric material, the material of the active body generates dielectric charges which are collected by the internal electrodes 121 to 124 and grouped on the external electrodes 111 to 114. The compression stress in region 101 creates a positive charge on electrodes 123. The tensile stress in region 102 creates a negative charge on electrodes 122. The average stress on region 103 being zero, no charge is accumulated on electrodes 124. Identically, when the substrate is accelerated in the −X direction, the stresses mentioned above are generated the same way, but with an opposite direction, which again introduce a charge in the electrodes.

When the substrate is accelerated in the Y direction, due to the weight of the inactive body added to its own weight, the active body experiences strain and stress. In average, the region 103 is compressed. Regions 101 and 102 are submitted to tensile stresses. Due to the properties of the piezoelectric material, the material of the active body generates dielectric charges which are collected by the internal electrodes and grouped on the external electrodes. The compression stress in region 103 creates a positive charge on electrodes 124. The tensile stress in regions 101 and 102 creates a negative charge on electrodes 123 and 122. Identically, when the substrate is accelerated in the −Y direction, the stresses mentioned above are generated the same way, but with an opposite direction, which again introduce a charge in the electrodes.

When the substrate is accelerated in the Z direction, due to the weight of the inactive body added to its own weight, the active body experiences strain and stress. All three regions 101, 102 and 103 are compressed. Due to the properties of the piezoelectric material, the material of the active body generates dielectric charges which are collected by the internal electrodes and grouped on the external electrodes. The compression stress in regions 101, 102 and 103 creates a positive charge on electrodes 123, 122 and 124 respectively. Identically, when the substrate is accelerated in the −Z direction, the stresses mentioned above are generated the same way, but with an opposite direction, which again introduce a charge in the electrodes.

These accumulations of dielectric charges on internal electrodes 122, 123 and 124 result in a voltage between external electrodes 114, 112 and 113 respectively with regard to the electrode 111 taken as a common reference. The acceleration of the substrate in X, Y and Z direction can be deduced from these voltages through linear relationships.

This embodiment of the present invention allows measuring the acceleration of the substrate in space. However, it can be noticed that the measurements are affected by variations in the ambient temperature. When temperature changes, the ceramic material also generates dielectric charges. These charges are created in all regions with similar polarity. They result in parasitic voltages being generated at the external electrodes and ultimately errors in the evaluation of the acceleration. Further embodiments of the present invention presented below aim at reducing these temperature effects and thus improve performance. The active body 10, according to a second of the embodiments of the invention, as illustrated in FIGS. 8 to 13, comprises 4 regions 201, 202, 203 and 204 with stacked internal electrodes 221, 223 and 221, 222 and 221, 225 and 221, 224 respectively. Each region comprises a supply structure consisting of external electrodes 213, 211 and 213, 215 and 213, 212 and 213, 214 respectively. The external electrode 213 is an external basis electrode which connects the four regions to a common ground potential.

The four layer regions 201 to 204 are shown in FIG. 10. The primary and the secondary regions 201 and 202 do not necessarily have to be of the same thickness as the tertiary and fourth regions 203 and 204, and similarly the regions 201 and 203, do not necessarily have to be of the same width as the regions 202 and 204.

A top view and a side view of the active body 10, in the second embodiment of the invention, are shown in FIGS. 8 and 9 respectively. In FIG. 9 the external basis electrodes 214 and 215 can be seen in their full extension.

The internal electrode configuration of the multilayer piezoelectric active body 10 in the second embodiment of the invention is illustrated in FIGS. 10 to 13. The active body 10 comprises four regions 201-204 which extend through the length of the active body 10.

As illustrated on FIG. 10 the primary region 201 is situated below the dotted line 232 and left for the dotted line 231, the secondary region 202 is situated below the dotted line 232 and right for the dotted line 231. The tertiary region 203 is situated above the dotted line 132, and left for the dotted line 231. The fourth region 204 is situated above the dotted line 232, and right for the dotted line 231.

The primary and secondary regions, respectively 201 and 202 (FIG. 10) contain alternately negative internal electrodes 221 (FIGS. 10 and 13) and positive internal electrodes, respectively 223 and 222 (FIGS. 10 and 12). The tertiary and fourth regions, respectively 203 and 204 (FIG. 10) contain alternately negative internal electrodes 221 (FIGS. 10 and 13) and positive internal electrodes, respectively 225 and 224 (FIGS. 10 and 11). All internal electrodes are insulated from each other by the ceramic material. They are enclosed in the ceramic block, except at selected places where they extend to the edge of the active body to connect with the external electrodes 211 to 215 (FIGS. 11-13). All the negative internal electrodes 221 are connected to the external basis electrode 213, and all the positive internal electrodes 223 of the primary region 201 are connected to the primary-external electrode 211. Accordingly all the positive internal electrodes 222, 224 and 225 are connected respectively to the external electrodes 215, 214 and 212.

The building and further processing of the ceramic body 10 of the second embodiment is carried out in a manner similar to the one described for the first embodiment of the invention.

The operating principle of the piezoelectric multilayer device 10 having the above structure is as follows:

When the substrate is accelerated in the X direction, due to the weight of the inactive body added to its own weight, the active body experiences strain and stress. Namely, the regions 201 and 203 are compressed. Regions 202 and 204 are submitted to tensile stresses. Due to the properties of the piezoelectric material, the material of the active body generates dielectric charges which are collected by the internal electrodes 221 to 225 and grouped on the external electrodes 211 to 215. The compression stress in regions 201 and 203 creates a positive charge on electrodes 223 and 225. The tensile stress in regions 202 and 204 creates a negative charge on electrodes 222 and 224.

Identically, when the substrate is accelerated in the −X direction, the stresses mentioned above are generated the same way, but with an opposite direction, which again introduce a charge in the electrodes.

When the substrate is accelerated in the Y direction, due to the weight of the inactive body added to its own weight, the active body experiences strain and stress. Namely, the regions 203 and 204 are compressed. Regions 201 and 202 are submitted to tensile stresses. Due to the properties of the piezoelectric material, the material of the active body generates dielectric charges which are collected by the internal electrodes and grouped on the external electrodes. The compression stress in regions 203 and 204 creates a positive charge on electrodes 225 and 224. The tensile stress in regions 201 and 202 creates a negative charge on electrodes 223 and 222.

Identically, when the substrate is accelerated in the −Y direction, the stresses mentioned above are generated the same way, but with an opposite direction, which again introduce a charge in the electrodes.

When the substrate is accelerated in the Z direction, due to the weight of the inactive body added to its own weight, the active body experiences strain and stress. All regions (201, 202, 203 and 204) are compressed. Due to the properties of the piezoelectric material, the material of the active body generates dielectric charges which are collected by the internal electrodes and grouped on the external electrodes. The compression stress in regions 201, 202, 203 and 204 creates a positive charge on electrodes 223, 222, 225 and 224.

Identically, when the substrate is accelerated in the −Z direction, the stresses mentioned above are generated the same way, but with an opposite direction, which again introduce a charge in the electrodes.

These accumulations of dielectric charges on internal electrodes 222, 223, 224 and 225 result in a voltage between external electrodes 215, 211, 214 and 212 respectively with regard to electrode 211 taken as a reference. The acceleration of the substrate in X, Y and Z direction can be deduced from these voltages through linear relationships.

In this embodiment, acceleration of the substrate in X and Y directions is deduced from a differential voltage, i.e. the difference in voltage between two regions. As mentioned above, changes in temperature would affect identically all the four regions. As a result, the acceleration in X and Y directions is less affected by changes in temperature than in the first embodiment.

The active body 10, according to a third of the embodiments of the invention, as illustrated in FIGS. 14 to 20, comprises 5 regions 301, 302, 303 and 304 and 305 with stacked internal electrodes 321, 323 and 321, 326 and 321, 325 and 321, 324 and 321, 322 respectively. Each region comprises a supply structure consisting of external electrodes 313, 311 and 313, 312 and 313, 316 and 313, 315 and 313, 314 respectively. The external electrode 313 is a common electrode which connects the five regions to a common ground potential.

The five layer regions 301 to 305 are shown in FIG. 16. The primary and fifth regions 301 and 305 do not necessarily have to be of the same thickness, and similarly the secondary, tertiary and fourth regions 302, 303 and 304 respectively, do not necessarily have to be of the same width.

A top view and a side view of the active body 10, in the third of the embodiments of the invention, are shown in FIGS. 14 and 15 respectively. In FIG. 15 the external electrodes 314, 315 and 316 can be seen in their full extension.

The internal electrode configuration of the multilayer piezoelectric active body 10 in the third embodiment of the invention is illustrated in FIGS. 16 to 20. The active body 10 comprises five regions 301-305 which extend through the length of the active body 10.

As illustrated on FIG. 16 the primary region 301 is situated below the dotted line 333 and left for the neutral plane 331, the secondary region 302 is situated between the dotted lines 333 and 334 and left for the dotted line 335. The tertiary region 303 is situated between the dotted lines 333 and 334 and between the dotted lines 335 and 336. The fourth region 304 is situated between the dotted lines 333 and 334 and right for the dotted line 336. The fifth region 305 is situated above the dotted line 334.

The primary region 301 (FIG. 16) contains alternately negative internal electrodes 321 (FIGS. 16 and 20) and positive internal electrodes 323 (FIGS. 16 and 19). The secondary, tertiary and fourth regions, respectively 302, 303 and 304 (FIG. 16) contain alternately negative internal electrodes 321 (FIGS. 16 and 20) and positive internal electrodes, respectively 326, 325 and 324 (FIGS. 16 and 18). The fifth region 305 (FIG. 16) contains alternately negative internal electrodes 321 (FIGS. 16 and 20) and positive internal electrodes 322 (FIGS. 16 and 17). All internal electrodes are insulated from each other by the ceramic material. They are enclosed in the ceramic block, except at selected places where they extend to the edge of the active body to connect with the external electrodes 311 to 316 (FIGS. 17-20). All the negative internal electrodes 321 are connected to the external electrode 313, and all the positive internal electrodes 323 of the primary region 301 are connected to the external electrodes 311. Accordingly all the positive internal electrodes 325, 326, 324 and 322 are connected respectively to the external electrodes 316, 312, 315, and 314.

The building and further processing of the ceramic body 10 of the third embodiment is carried out in a manner similar to the one described for the first embodiment of the invention.

The piezoelectric multilayer device 10 having the above structure operates as follows:

When the substrate is accelerated in the X direction, due to the weight of the inactive body added to its own weight, the active body experiences strain and stress. Namely, the region 302 is compressed. Region 304 is submitted to tensile stresses. Regions 301, 303 and 305 also bend, however the neutral plane 331 of the active body being placed in their middle, the average stress in these regions is zero.

Due to the properties of the piezoelectric material, the material of the active body generates dielectric charges which are collected by the internal electrodes 321 to 326 and grouped on the external electrodes 301 to 316. The compression stress in region 302 creates a positive charge on internal electrodes 326. The tensile stress in region 304 creates a negative charge on internal electrodes 324. The average stress on the other regions being zero, no charge is accumulated on electrodes 323, 325 and 322. These accumulations of dielectric charges result in a voltage between external electrodes 312 and 315. This voltage is thus a direct image of the acceleration of the substrate in X direction.

Identically, when the substrate is accelerated in the −X direction, the region 304 is compressed and the region 302 is pulled. This, however, again results in an electrical charge between electrodes 312 and 315.

When the substrate is accelerated in the Y direction, the active body experiences strain and stress due to the weight of the inactive body added to its own weight. Namely, the region 301 is compressed. Region 305 is submitted to tensile stresses. Regions 302, 303 and 304 also bend, however the neutral plane 332 being placed in their middle, the average stress in these regions is zero. Due to the properties of the piezoelectric material, the material of the active body generates dielectric charges which are collected by the internal electrodes and grouped on the external electrodes. The compression stress in region 301 creates a positive charge on electrodes 323. The tensile stress in region 305 creates a negative charge on electrodes 322. The average stress on the other regions being zero, no charge is accumulated on electrodes 326, 325 and 324. These accumulations of dielectric charges result in a voltage between external electrodes 311 and 314. This voltage is thus a direct image of the acceleration of the substrate in the Y direction.

Identically, when the substrate is accelerated in the −Y direction, the region 305 is compressed and the region 301 is pulled. This results in an electrical charge between electrodes 311 and 314.

When the substrate is accelerated in the Z direction, due to the weight of the inactive body added to its own weight, the active body experiences strain and stress. All regions are compressed. In particular, region 303 is compressed. Due to the properties of the piezoelectric material, the material of the active body generates dielectric charges which are collected by the internal electrodes and grouped on the external electrodes. The compression stress in region 303 creates a positive charge on electrodes 325. This accumulation of dielectric charges results in a voltage between electrodes 316 and 313. This voltage is thus a direct image of the acceleration of the substrate in Z direction.

Identically, when the substrate is accelerated in the −Z direction, the region 303 is pulled. This results in a voltage between electrodes 316 and 313.

This embodiment provides similar performance as the second embodiment. The difference lies in the presence of a dedicated region for sensing acceleration in the Z direction. This allows separating completely the external circuits necessary for sensing voltage which can in some cases be an advantage for the whole system.

With regards to temperature compensation, we can consider the region 305 and the region 301 being naturally used for temperature compensation since these two regions are symmetrical with regard to a plane parallel to the stacking plane (perpendicular to the Y axis) dividing the device into two identically thick parts, c.f. plane 332 in FIG. 16.

FIG. 21 illustrates a fourth embodiment of the present invention, wherein the active body 11 is rigidly fixed to the substrate 14 at both ends e.g. adhesively or by mechanical clamping, if necessary through the use of a fork 13. The inactive body 12 is rigidly fixed to the active body somewhere at the length of the body, preferably in its middle e.g. adhesively or by mechanical clamping.

The active body 11, according to the fourth embodiment of the invention, as illustrated in FIGS. 21 to 29, comprises 6 regions 401, 402, 403, 404, 405 and 406 with stacked internal electrodes 421, 427 and 421, 425 and 421, 426 and 421, 423 and 421, 422 and 421, 426 respectively.

As illustrated on FIG. 24 the primary region 401 is situated below the dotted line 433 and left for the neutral plane 431, the secondary region 402 is situated between the dotted lines 433 and 434 and left for the dotted line 435. The tertiary region 403 is situated between the dotted lines 433 and 434 and between the dotted lines 435 and 436. The fourth region 404 is situated between the dotted lines 433 and 434 and right for the dotted line 436. The fifth region 405 is situated above the dotted line 434. On FIG. 25 the sixth region is illustrated, as situated between the dotted lines 433 and 434 and between the dotted lines 435 and 436.

Each region comprises a supply structure consisting of external electrodes 411, 415 and 411, 414 and 411, 417 and 411, 416 and 411, 415 respectively. The external electrode 411 is a common electrode which connects the five regions to a common ground potential.

The six layer regions 401 to 406 are shown in FIGS. 24 and 25. The primary and fifth regions 401 and 405 do not necessarily have to be of the same thickness, and similarly the secondary, tertiary/sixth, and fourth regions 402, 403/406 and 404 respectively, do not necessarily have to be of the same width, and similarly the tertiary and sixth regions 403 and 406 does not necessarily have to be of the same length.

A top view and a side view of the active body 11, in the fourth embodiment of the invention, are shown in FIGS. 22 and 23 respectively. In FIG. 23 the external electrodes 412, 413 and 414 can be seen in their full extension.

The internal electrode configuration of the multilayer piezoelectric active body 11 in the fourth embodiment of the invention is illustrated in FIGS. 21 to 29. The active body 11 comprises six regions 401-406 which extend through the length of the active body 11.

The primary region 401 (FIGS. 24 and 25) contains alternately negative internal electrodes 421 (FIGS. 24, 25 and 29) and positive internal electrodes 427 (FIGS. 24 and 28). The secondary, tertiary and fourth regions, as seen in the cross-sectional view taken along the line A-A on FIG. 22, and illustrated in FIG. 24, respectively regions 402, 403 and 404, contain alternately negative internal electrodes 421 (FIGS. 24 and 29) and positive internal electrodes, respectively 423, 424 and 425 (FIGS. 24 and 27). Similarly the fourth, sixth and secondary regions, as seen in the cross-sectional view taken along the line B-B on FIG. 22, and illustrated in FIG. 25, respectively regions 404, 406 and 402, contain alternately negative internal electrodes 421 (FIGS. 25 and 29) and positive internal electrodes, respectively 425, 426 and 423 (FIGS. 25 and 27). The fifth region 405 (FIGS. 24 and 25) contains alternately negative internal electrodes 421 (FIGS. 24, 25 and 29) and positive internal electrodes 422 (FIGS. 24, 25 and 26). All internal electrodes are insulated from each other by the ceramic material. They are enclosed in the ceramic block, except at selected places where they extend to the edge of the active body to connect with the external electrodes 411 to 415 (FIGS. 26-29). All the negative internal electrodes 421 are connected to the external electrode 411, and all the positive internal electrodes 427 of the primary region 401 are connected to the external electrodes 413. Accordingly all the positive internal electrodes 422, 423, 424, 425 and 426 are connected respectively to the external electrodes 415, 416, 412, 414 and 417.

The building and further processing of the ceramic body 11 of the fourth embodiment is carried out in a manner similar to the one described for the first embodiment of the invention.

The operating principle of the piezoelectric multilayer device 11 having the above structure is as follows:

When the substrate is accelerated in the X direction, due to the weight of the inactive body added to its own weight, the active body experiences strain and stress. Namely, the region 404 is compressed. Region 402 is submitted to tensile stresses. Regions 401, 403, 405 and 406 also bend, however the neutral plane 431 being placed in their middle, the average stress in these regions is zero.

Due to the properties of the piezoelectric material, the material of the active body generates dielectric charges which are collected by the internal electrodes and grouped on the external electrodes. The compression stress in region 404 creates a positive charge on electrodes 425. The tensile stress in region 402 creates a negative charge on electrodes 423. These accumulations of dielectric charges on internal electrodes 425 and 423 result in a voltage between external electrodes 414 and 416. This voltage is thus a direct image of the acceleration of the substrate in the X direction.

Identically, when the substrate is accelerated in the −X direction, the stresses mentioned above are generated the same way, and a charge is generated.

When the substrate is accelerated in the Y direction, due to the weight of the inactive body added to its own weight, the active body experiences strain and stress. Namely, the region 405 is compressed. Region 401 is submitted to tensile stresses. Regions 402, 403, 404 and 406 also bend, however the neutral plane 432 being placed in their middle, the average stress in these regions is zero.

Due to the properties of the piezoelectric material, the material of the active body generates dielectric charges which are collected by the internal electrodes and grouped on the external electrodes. The compression stress in region 405 creates a positive charge on electrodes 422. The tensile stress in region 401 creates a negative charge on electrodes 427.

These accumulations of dielectric charges on internal electrodes 422 and 427 result in a voltage between external electrodes 415 and 413. This voltage is thus a direct image of the acceleration of the substrate in the Y direction. Identically, when the substrate is accelerated in the −Y direction, the stresses mentioned above are generated the same way, but with an opposite direction, and an electrical charge is generated.

When the substrate is accelerated in the Z direction, due to the weight of the inactive body added to its own weight, the active body experiences strain and stress. Region 403 is compressed. Region 406 is submitted to tensile stresses. The other regions are also submitted to stresses, however the effect of these stresses is the same on all regions, so that the differential voltage outputs mentioned above are not affected.

Due to the properties of the piezoelectric material, the material of the active body generates dielectric charges which are collected by the internal electrodes and grouped on the external electrodes. The compression stress in region 403 creates a positive charge on electrodes 424. The tensile stress in region 406 creates a negative charge on electrodes 426.

These accumulations of dielectric charges on internal electrodes 424 and 426 result in a voltage between external electrodes 412 and 417. This voltage is thus a direct image of the acceleration of the substrate in the X direction.

Identically, when the substrate is accelerated in the −Z direction, the stresses mentioned above are generated the same way, but with an opposite direction, and an electrical charge is generates.

This design provides different output characteristics than the other embodiments. In particular, the measurement of acceleration in Z direction is less sensitive to variations in ambient temperature.

In this embodiment, acceleration of the substrate in X, Y and Z directions is deduced from a differential voltage, i.e. the difference in voltage between two regions. As mentioned above, changes in temperature would affect identically all the six regions. As a result, the acceleration in X, Y and Z directions is less affected by changes in temperature than in the other embodiments.

With regards to temperature compensation, we can consider the sensing region in the “Z” (length) direction being the region 403, the temperature compensation region should be symmetrical with regard to the plane perpendicular to the length of the device, cutting it into two equally long parts, therefore region 406.

The regions of all embodiments of the invention, are divided by dotted lines on FIGS. 4, 10, 16, 24 and 25. These dotted lines are for illustrative purpose only; the body contains no physical separation between the regions.

All the regions may be made of piezoelectric material, but the regions may also be made of an electrostrictive material.

The piezoelectric material may be selected from the group of materials containing piezoelectric ceramics such as PZT (lead zirconium titanate) and PZT-type ceramics, e.g., Mn and Sb-doped PZT (PMSZT) and Nb-doped PZT (PNZT) as well as a number of doped PZT materials of the general formula (Pb1−xMx)(Zr1−yTiy)O₃+M1O (M=Sr, Ba, Ca, Mg; M1=Ta, Nb, W, Mo, Cr, Mn, Fe, Co, Ni, Zn, Y, Bi, Sb, Sm, Nd, Si, Ge, B; x=0-0.3; y=0-1.0). Furthermore, the piezoelectric material may be selected from the group of materials containing piezoelectric ceramics such as La-doped PZT (PLZT), PMN (lead magnesium niobate) and PMN-type ceramics, or BaTiO3. The piezoelectric ceramics may be single crystalline or polycrystalline.

Alternatively, the active body may also be made from a piezoresistive material. In this case, the material does not generate charge but exhibits a change in resistance. The control system needs to be adapted to sense this change in resistance.

1. An accelerometer comprising an active body of a piezo-material, electrodes embedded in the active body and external connectors facilitating connection of the electrodes to an external control system, wherein the electrodes are arranged to form at least a first, a second and a third sensing region, each sensing region comprising a plurality of first order electrodes being electrically separated from a plurality of second order electrodes, wherein the first order electrodes and the second order electrodes are stacked in a thickness direction between layers of the piezo-material.

2. An accelerometer according to claim 1, wherein the electrodes extend primarily in the same lengthwise direction, being transverse to the thickness direction.

3. An accelerometer according to claim 1, wherein each electrode extends substantially parallel to the other electrodes in the stack of electrodes.

4. An accelerometer according to claim 1, comprising a portion with two stacks of electrodes arranged adjacently.

5. An accelerometer according to claim 1, further comprising a control system adapted to communicate with the electrodes of each of the sensing regions to derive therefrom an electrical acceleration signal being significant for an acceleration profile for the active body.

6. An accelerometer according to claim 5, comprising at least one temperature compensation region comprising first order temperature compensation electrodes and second order temperature compensation electrodes embedded in the active body, the control system being adapted to communicate with the electrodes in the temperature compensation region to derive therefrom an electrical compensation signal and to compensate the electrical acceleration signal for temperature changes based on the temperature compensation signal.

7. An accelerometer according to claim 6, wherein each temperature compensation region is arranged such that a dielectric charge or change in resistance generated therein upon acceleration is equal and opposite to the signal generated in one or more of the sensing regions whereas the signal generated therein upon temperature change is equal and of same sign as the signal generated in one or more of the sensing regions.

8. An accelerometer according to claim 6, comprising for each sensing region, a corresponding temperature compensation region, each sensing region and the corresponding temperature compensation region being arranged symmetrically relative to a plane containing the geometrical centre point of the active body.

9. An accelerometer according to claim 8, wherein the plane is perpendicular to a direction of acceleration which is being determined by the sensing region in question.

10. An accelerometer according to claim 5, wherein the control system is adapted for charge amplification of the electrical signals.

11. An accelerometer according to claim 1, further comprising at least one inactive body attached to the active body.

12. An accelerometer according to claim 11, wherein the inactive body has a mass different from that of the active body.

13. An accelerometer according to claim 11, wherein the inactive body is located at a distance from the active body, the two bodies being joined by a connection element.

14. An accelerometer according to claim 11, wherein the inactive body is made from a piezoelectric material or from a piezoresistive material.

15. An accelerometer according to claim 1, wherein the active body is co-fired.

16. An accelerometer according to claim 14, wherein the inactive body and the active body are co-fired to form a single continuous body.

17. An accelerometer according to claim 1, comprising at least one external basis electrode, an external primary-electrode, an external secondary-electrode, and an external tertiary-electrode, each external basis electrode being in conductive contact with the internal first order electrodes of at least the first, second and third sensing region, each external primary-electrode being in electrical conductive contact with the second order electrodes of the first sensing region, each an external secondary-electrode being in electrical conductive contact with the second order electrodes of the second sensing region, and each external tertiary-electrode being in electrical conductive contact with the second order electrodes of the third sensing region, wherein all basis electrodes have identical electrical potential.

18. An accelerometer according to claim 1, wherein at least some of the electrodes of the first sensing region have a shape which is different from at least some of the electrodes of the second sensing region.

19. An accelerometer according to claim 1, wherein at least some of the electrodes of the first sensing region have a shape which is different from at least some of the electrodes of the third sensing region.

20. A method of determining acceleration by use of a body of a piezo material which comprises at least three sensing regions, where each sensing region comprises an individual set of electrodes separated by piezoelectric or piezoresistive material, the method comprising the step of processing electrical signals from each sensing region to provide an acceleration profile of the body.

21. A method according to claim 20, comprising combining an electrical signal from each of the sensing regions in one single model which describes a correlation between the electrical signals and an acceleration of a substrate to which the piezoelectric body is attached.

22. A method according to claim 20, further comprising the step of combining an electrical signal from each of the sensing regions with a signal from a temperature compensation region to provide a more temperature independent acceleration profile of the body.

23. A method according to claim 20, the method comprising comparing an electrical signal from each of the sensing regions with a reference value, and considering a specific acceleration state based on the comparison.
